(19) United States
(12) Patent Application Publication
(10) Pub. No.: US 2007/0104441 A1
(43) Pub. Date: May 10, 2007

(54) Laterally-integrated waveguide photodetector apparatus and related coupling methods

(75) Inventors: Donghwan Ahn, Cambridge, MA (US); Jifeng Liu, Cambridge, MA (US); Jurgen Michel, Arlington, MA (US); Lionel C. Kimerling, Concord, MA (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(73) Assignee: Massachusetts Institute of Technology, Cambridge, MA (US)

(21) Appl. No.: 11/269,907

(22) Filed: Nov. 8, 2005

(51) Int. Cl. G02B 6/10; G02B 6/26; G02B 6/42

(52) U.S. Cl. 385/129; 385/130; 385/131; 385/132; 385/15; 385/39; 385/50; 385/49; 385/27; 385/30; 385/88

(57) ABSTRACT

High-speed optoelectronic devices having a waveguide densely integrated with and efficiently coupled to a photodetector are fabricated utilizing methods generally compatible with CMOS processing techniques. In various implementations, the waveguide consists essentially of single-crystal silicon and the photodetector contains, or consists essentially of, epitaxially grown germanium or a silicon-germanium alloy having a germanium concentration exceeding about 90%.

### FIELD OF THE INVENTION

This invention relates generally to optoelectronic devices and, specifically, to methods and materials for fabrication of waveguide-based photodetector devices.

### BACKGROUND OF THE INVENTION

Various optoelectronic applications, such as optical telecommunications and intra-chip interconnects, involve transmitting optical signals and converting them to electrical signals at high data rates. Systems for performing such transmission and conversion usually require photodetector devices compatible with the speed and bandwidth of the optical signal. Typically, these devices are PIN detectors—i.e. semiconductor devices including an intrinsic region sandwiched between a p-type region and an n-type region—that have frequency response in the GHz range and utilize optical waveguides as a conduit for directing light to the intrinsic region of the photodetector.

Generally, an optical waveguide is a planar, rectangular, or cylindrical structure having a high-index core surrounded by a low-index cladding. Light rays are predominantly confined in the core by internal reflection at the core/cladding interface, with a small portion of the light propagating in the cladding as an evanescent wave. In order to form a high-speed waveguide-based photodetector, a lightwave traveling in the optical waveguide is coupled to the intrinsic region of the photodetector, where the light is converted to photon-generated carriers. The carriers then diffuse out to the electrodes, e.g. the p- and n-type regions of the PIN detector, producing an electrical signal (e.g., a photocurrent) that corresponds to the detected light. To reduce scattering and improve detection efficiency, the intrinsic region of a PIN photodetector needs to be in direct contact with or sufficiently close to either a waveguide's butt end or to its surface. In the latter case, light can be coupled to the intrinsic region via the evanescent wave, a phenomenon referred to as “evanescent coupling.”

The speed of the detector generally depends on the time it takes for the photon-generated carriers to reach the electrodes. This time is referred to as the “transit time.” The narrower the intrinsic region, the shorter the transit time and the faster the detector. A fast photodetector allows for the detection and processing of high-speed optical signals.

As mentioned above, one potential application of such integrated photodetector devices relates to optical intra-chip interconnects. Recently, the increasing computing power of modern microelectronic devices has given rise to the need for smaller transistors and increased operating speeds that translate to higher density metallic interconnect lines carrying more current. The smatter cross-sectional dimensions of interconnects, however, generally lead to resistance-capacitance time delays and electromigration failure issues. Furthermore, the clock distribution typically consumers as much as 70% of the total power dissipated on a chip. Thus, conventional interconnects may impede further developments in microelectronic technology. In that regard, integrated photodetector devices present a promising alternative to the metallic interconnects, enabling novel microprocessor architectures by permitting significant increases in the intra- and inter-chip data transfer rates and reducing power consumption.

Implementation of these integrated photodetectors as optical interconnects for microelectronic devices, however, presents a number of challenges because different fabrication techniques are typically employed for microelectronic and optical components. Thus, it is desirable to incorporate the optical components onto a chip without jeopardizing CMOS processing compatibility or interfering with the operation of CMOS devices. In that regard, silicon-on-insulator (“SOI”) substrates, commonly used in CMOS fabrication, are particularly attractive for incorporating optical components with microelectronic devices. Specifically, using SOI as a starting substrate, low-loss waveguides can be defined in the top silicon layer. The high retractive index contrast between silicon and its oxide enables high light confinement in microscale strip waveguides. With respect to the photodetector, however, many applications having optical components that operate at wavelengths longer than silicon's absorption edge (1.3 μm to 1.55 μm) require an active material other than pure silicon to achieve acceptable absorption levels and generate photocurrent. Bulk germanium and/or silicon-germanium compounds have been previously proposed as suitable candidates for the photodetector material in silicon-based integrated waveguide photodetectors. See, for example, “Integration of Germanium Waveguide Photodetectors for Optical Intra-Chip Interconnects” by Rouvière et al. (Proceedings of SPIE, vol. 5453, 2004) and “Strain-Balanced Silicon-Germanium Materials for Near IR Photodetection in Siticon-Based Optical Interconnects” by Giovane (Ph.D. Thesis, MIT, 1998), both incorporated herein by reference.

Known approaches for integrating germanium-based photodetectors with silicon-based waveguides, however, suffer from several process- and performance-related drawbacks, including poor confinement and coupling efficiency, suboptimal integration density, and complexity of fabrication.

Thus, there is a need in the art for versatile and cost-effective methods of fabricating integrated waveguide-based photodetector devices that are generally compatible with CMOS processing techniques. There is also a need in the art for integrated high-speed waveguide-based photodetector device with improved detection capabilities and integration density.

### SUMMARY OF THE INVENTION

Heterointegration of lattice-mismatched materials is desirable for various electronic and optoelectronic applications. For example, as mentioned above, the possibility of the heterointegration of III-V, II-VI materials, and/or Ge with Si is an attractive path for fabricating integrated devices transmitting optical signals and converting them to electrical signals at high data rates. Selective epitaxy is particularly suitable for such integration because it allows adding the non-Si semiconductor material only where it is needed, and thus is only marginally, if at all, disruptive to a Si CMOS process performed on the same wafer. Also, selective epitaxy may allow the combination of multiple lattice-mismatched materials on a common wafer.

Accordingly, it is an object of the present invention to provide optoelectronic devices that address both process- and performance-related limitations of known approaches. Generally, in its various aspects and embodiments, the invention disclosed herein focuses on optoelectronic devices having a waveguide densely integrated with and efficiently coupled to a photodetector, as well as on optoelectronic circuits employing such devices. The invention also features methods for fabricating such integrated devices preferably utilizing selective epitaxy and being generally compatible with CMOS processing techniques.

In general, in one aspect, the invention features an integrated photodetector apparatus including a substrate having a first cladding layer disposed over a base layer and an optical waveguide disposed over the substrate. The first cladding layer defines an opening extending to the base layer. The base layer and the optical waveguide contain, or consist essentially of, a first semiconductor material. The apparatus further includes a photodetector including, or consisting essentially of, a second semiconductor material epitaxialty grown over the base layer at least in the opening. The photodetector has an intrinsic region optically coupled to the waveguide. At least a portion of the intrinsic region extends above the first cladding layer and is laterally aligned with the waveguide.

In another aspect, the invention relates to an integrated photodetector apparatus including an optical waveguide disposed over a substrate having a first cladding layer disposed over a base layer. The first cladding layer contains, or consists essentially of, silicon dioxide and defines an opening extending to the base layer. The optical waveguide and the base layer contain, or consist essentially of, single-crystal silicon. The photodetector apparatus further includes an intermediate silicon layer disposed in the opening over the base layer and having a first doped region formed therein. Also, the photodetector apparatus includes a photodetector having a second doped region and an intrinsic region thereunder optically coupled to the waveguide. At least a portion of the intrinsic region extends above the first cladding layer and in lateral alignment with the waveguide. One of the doped regions includes a source region and the other doped region includes a drain region. The photodetector contains, or consists essentially of, a semiconductor material epitaxially grown at least in the opening over the intermediate layer.

In yet another aspect, the invention relates to an integrated photodetector apparatus including a substrate having a first cladding layer disposed over a base layer and an optical waveguide disposed over the substrate. The first cladding layer defines an opening extending to a first portion of the base layer. The base layer and the optical waveguide contain, or consist essentially of, a first semiconductor material. Also, the base layer has a first doped region formed at least in the first portion of the base layer. The apparatus further includes a photodetector including, or consisting essentially of, a second semiconductor material epitaxially grown over the base layer at least in the opening over the source region. The photodetector has a second doped region and an intrinsic region thereunder optically coupled to the waveguide. At least a portion of the intrinsic region extends above the first cladding layer and is laterally aligned with the waveguide. One of the doped regions includes a source region and the other doped region includes a drain region.

In various embodiments of this and/or other aspects of the invention, the intrinsic region of the photodetector is either butt-coupled or is evanescently coupled to the optical waveguide. Optionally, the portion of the intrinsic region of the photodetector is adjacent to the optical waveguide, forming substantially gapless interface therebetween. Also, the photodetector may include a source and a drain regions separated by the intrinsic region. Further, an intermediate semiconductor layer, for example, including, or consisting essentially of, silicon, may be disposed over the base layer in the opening underneath the photodetector.

In this and/or other aspects of the invention, the first semiconductor material may contain, or consist essentially of, single-crystal silicon. Also, the first cladding layer may contain, or consist essentially of, silicon dioxide. The photodetector may contain, or consist essentially of, germanium or a silicon-germanium alloy having a germanium concentration exceeding about 90%. The intermediate semiconductor layer may contain, or consist essentially of, silicon or silicon-germanium. Also, the photodetector apparatus may also include (i) contact regions in electrical communication with the source and the drain regions and/or (ii) a second cladding layer disposed over the optical waveguide and the photodetector. The second cladding layer may contain, or consist essentially of, silicon dioxide.

Further, in many embodiments of this and/or other aspects of the invention, the thickness of the photodetector does not exceed about 1.5 μm. In various embodiments, the waveguide is a single-mode structure. In some versions of these embodiments, the thickness of the optical waveguide is less than about 1 μm, for example, is about 0.2 μm. Also, in these or other versions, a width of the waveguide is less than about 1 μm, or, in a particular version, is about 0.5 μm.

Also, in two further aspects, the invention relates to an optoelectronic circuit that includes an integrated photodetector apparatus, a light source, and an electronic device. In particular, in one of these aspects, the photodetector apparatus includes (i) an optical waveguide disposed over a substrate including a first cladding layer disposed over a base layer, and (ii) a photodetector having a source region and a drain region separated by an intrinsic region optically coupled to the optical waveguide. The first cladding layer defines an opening extending to the base layer and contains, or consists essentially of, silicon dioxide. Also, the optical waveguide and the base layer contain, or consist essentially of, single-crystal silicon. Further, the photodetector layer contains, or consists essentially of, a semiconductor material epitaxially grown over the base layer at least in the opening. At least a portion of the intrinsic region of the photodetector extends above the first cladding layer in lateral alignment with the waveguide. In the other aspect, the photodetector apparatus includes an optical waveguide disposed over a substrate including a first cladding layer disposed over a base layer. The first cladding layer defines an opening extending to a first portion of the base layer and contains, or consists essentially of, silicon dioxide. The base layer has a first doped region formed at least in the first portion of the base layer. The optical waveguide and the base layer contain, or consist essentially of, single-crystal silicon. The photodetector apparatus further includes a photodetector including (i) a semiconductor material epitaxially grown over the base layer at least in the opening over the source region, and (ii) a second doped region and an intrinsic region thereunder optically coupled to the waveguide. At least a portion of the intrinsic region extends above the first cladding layer and in lateral alignment with the waveguide. One of the doped regions includes a source region and the other doped region includes a drain region.

Within the optoelectronic circuits according to both aspects described above, the light source is in optical communication with an input end of the optical waveguide for directing a lightwave thereto, and the electronic device is electrically coupled to the source and drain regions for receiving and processing an electrical signal generated in the photodetector.

In yet another two aspects, in general, the invention relates to methods for manufacturing an integrated photodetector apparatus. In one of these aspects, the method includes providing a silicon-on-insulator substrate having a top layer, an insulator layer, and a base layer and then partially removing the top layer to form an optical waveguide over the insulator layer. The method further includes depositing a cladding layer containing, or consisting essentially of, silicon dioxide over the optical waveguide and the insulator layer; forming an opening at least in the cladding and the insulator layers that extends to a first portion of the base layer; and epitaxially growing a lattice-mismatched semiconductor layer over the first portion of the base layer at least in the opening such that at least a portion of the semiconductor layer extends above the insulator layer to form a photodetector including an intrinsic region optically coupled to the waveguide. In the other aspect, the method includes forming a first insulator layer over a silicon substrate having a first doped region formed therein and then forming an optical waveguide over the insulator layer. The optical waveguide contains, or consists essentially of, silicon, silicon nitride, or silicon oxynitride. The method further includes depositing a second insulator layer over the optical waveguide and the insulator layer; forming an opening in the first and second insulator layers that extends to a first portion of the substrate; and epitaxially growing a compositionally-uniform lattice-mismatched semiconductor layer directly over the first portion of the substrate at least in the opening. At least a portion of the semiconductor layer extends above the insulator layer to form a photodetector including an intrinsic region optically coupled to the waveguide.

Embodiments of at least one of these two aspects of the invention include the following features. A first doped region can be formed in the first portion of the base layer prior to epitaxially growing a lattice-mismatched semiconductor layer. Also, a second doped region can be formed in the photodetector. One of the doped regions can include a source region and the other doped region can include a drain region. Also, contact regions electrically coupled to the source and drain regions can be formed. In various embodiments, the intrinsic region of the photodetector is either butt-coupled or is evanescently coupled to the optical waveguide. Optionally, the portion of the intrinsic region of the photodetector is adjacent to the optical waveguide, forming substantially gapless interface therebetween. In some embodiments, an intermediate silicon layer is formed in the opening over the base layer and then a first doped region is formed in the intermediate silicon layer prior to epitaxially growing a lattice-mismatched semiconductor layer thereover. The lattice-mismatched semiconductor layer may contain, or consist essentially of, germanium or a silicon-germanium alloy having a germanium concentration exceeding about 90%.

Optionally, the step of epitaxially growing the lattice-mismatched semiconductor layer includes (i) depositing a semiconductor material over the interface layer at a first temperature to form a buffer layer; and (ii) depositing the semiconductor material over the buffer layer at a second temperature until a final thickness is obtained. A thickness of the buffer layer may range from about 30 nm to about 60 nm. In various embodiments, the final thickness does not exceed about 1.5 μm. Also, the second temperature can be greater than the first temperature. The step of epitaxially growing the lattice-mismatched semiconductor layer may further include annealing the semiconductor material, for example, at a temperature greater than about 850° C. for at least 15 minutes, or by rapid thermal annealing at a temperature greater than about 850° C. for about 3 minutes.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which

FIGS. 1A-1B, 2A-2C, 3A-3B, 4A-4C, and 5A-5B depict schematic perspective and cross-sectional side and/or transverse views illustrating formation of integrated waveguide-based photodetector devices according to various embodiments of the claimed invention,

FIG. 5C depicts an optical simulation of a transverse field profile for the embodiment of the evanescently-coupled integrated device shown in FIG. 5B with a 0.1-μm gap between the waveguide and the photodetector;

FIGS. 6A-6C depict schematic cross-sectional side views illustrating formation of integrated waveguide-based photodetector devices according to alternative embodiments of the claimed invention; and

FIGS. 7A-7B depict perspective views of optoelectronic circuits utilizing integrated devices formed as illustrated in the preceding Figures.

### DETAILED DESCRIPTION

In accordance with its various embodiments, the invention disclosed herein contemplates fabrication of integrated waveguide-based photodetector apparatus with improved detection capabilities and integration density utilizing methods that are generally compatible with CMOS processing techniques. Also contemplated are optoetectronic circuits including at least one integrated photodetector apparatus, a light source for directing a lightwave thereto, and one or more electronic devices for receiving and processing an electrical signal generated in the photodetector apparatus.

As discussed in more detail below, efficient coupling between components in the integrated apparatus of the invention is facilitated by epitaxially growing a photodetector in lateral alignment with an optical waveguide. Selective epitaxy is suitable for fabricating optoelectronic devices according to many embodiments of the invention because it is only marginally, if at all, disruptive to a conventional CMOS process performed on the same wafer, and, therefore, is particularly attractive for incorporating optical components with microelectronic devices.

While generally described in connection with germanium or silicon-germanium photodetectors integrated with silicon or silicon-based optical waveguides employing silicon or SOI wafers as starting substrates, the invention is not thusly limited and other materials and starting substrates are contemplated without departing from the scope or spirit of the invention.

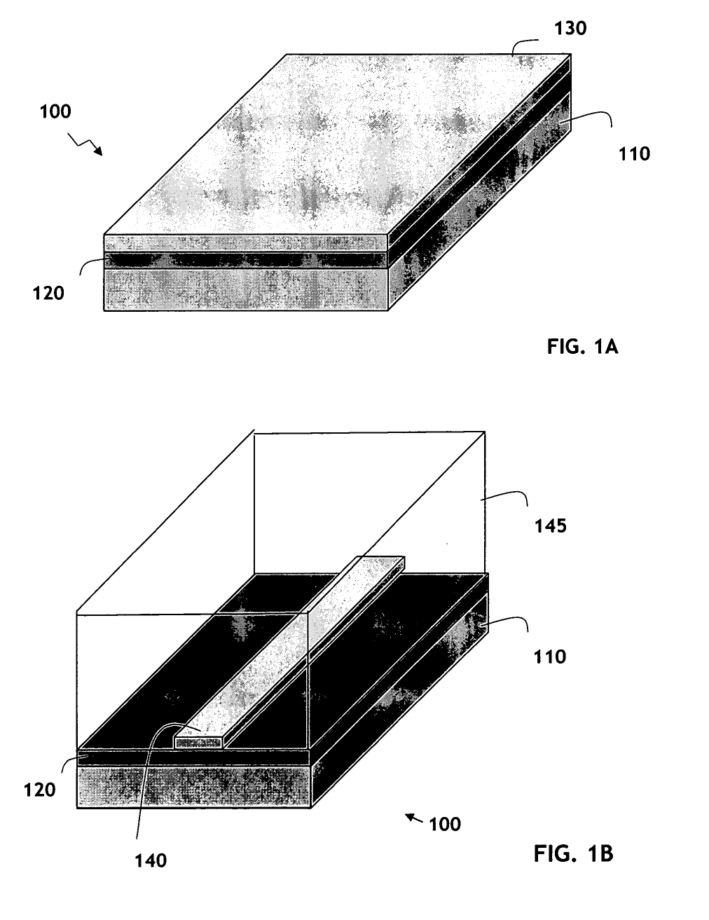

Referring to FIGS. 1A-1B, in various embodiments, fabrication of the integrated waveguide-based photodetector apparatus having lateral PIN configuration starts with a substrate 100 having a base semiconductor layer 110 and an insulator layer 120 disposed thereon. The insulator layer will ultimately serve as a bottom cladding layer of the waveguide. Further, a top semiconductor layer 130 is disposed over the insulator layer. In a particular embodiment, the substrate 100 is a SOI wafer such that the top and the base semiconductor layers consist essentially of single-crystal silicon and the insulator layer consists essentially of silicon dioxide. A waveguide 140 is defined in the layer 130, for example, by masking the desired configuration of the waveguide using a patterned photoresist layer and then etching the exposed portions of the layer 130. A top cladding layer 145 (depicted in FIG. 1B as having visible edges and transparent sides for illustration purposes) is deposited over the waveguide 140 and the insulator layer 120 by, for example, any of conventional chemical vapor deposition techniques. In many embodiments, the top cladding layer contains, or consists essentially of, silicon dioxide or silicon oxynitride.

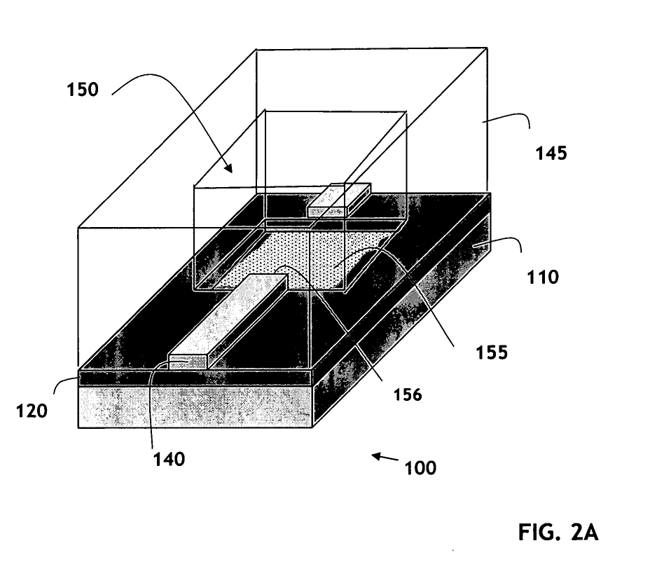

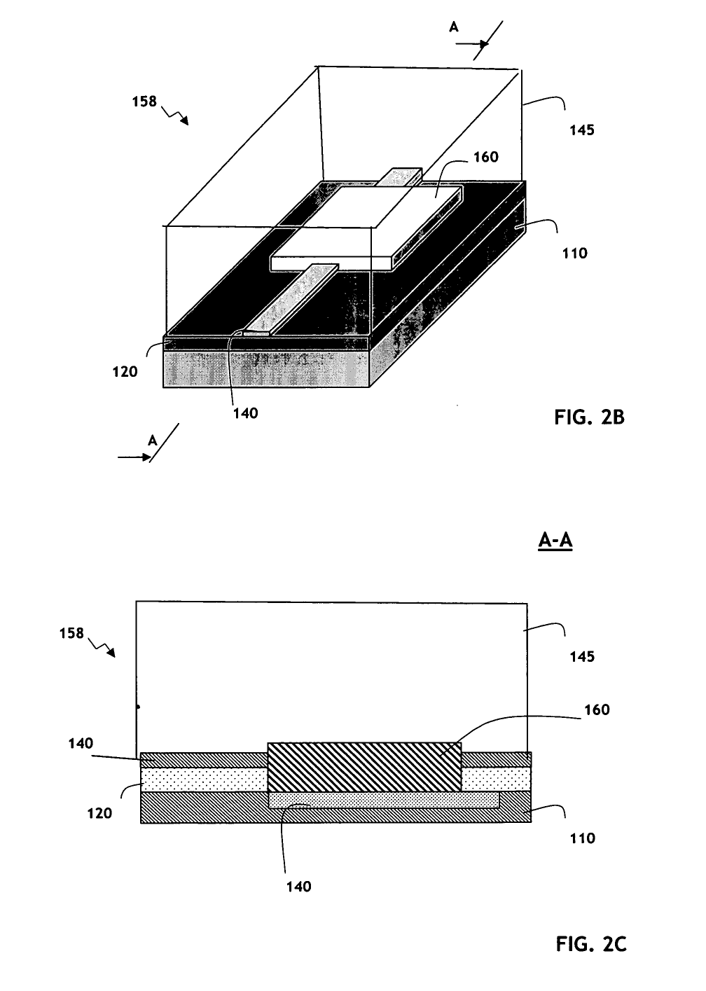

Referring to FIG. 2A, an opening 150 is then defined in the substrate 100 through the top cladding layer and the insulator layer, and, optionally, through (or adjacent to) the top semiconductor later, extending to the top surface of the base layer. The opening can be formed by any method known in the art, for example, by applying a patterned photoresist layer over the top semiconductor layer followed by etching of portions of the layers exposed by the photoresist. In some embodiments, a first doped region 155 is then formed in the exposed portion of the base layer by any of the methods known in the art, for example, by dopant implantation. In other embodiments, a thin layer (not shown) of the same semiconductor material as the material of the base layer 110, for example, silicon, is deposited in the opening 150 over the exposed portion of the base layer, followed by the formation of the first doped region in such thin layer. Examples of suitable dopants are n-type dopants such as phosphorus, arsenic, and antimony, or a p-type dopant, such as boron. Dopant ions may be implanted by directing a dopant-containing gas, such as phosphine, arsine, stibine, and/or diborane, at the exposed portion of the top layer. The dopant gas is typically diluted in a carrier gas to, for example, approximately 1% concentration.

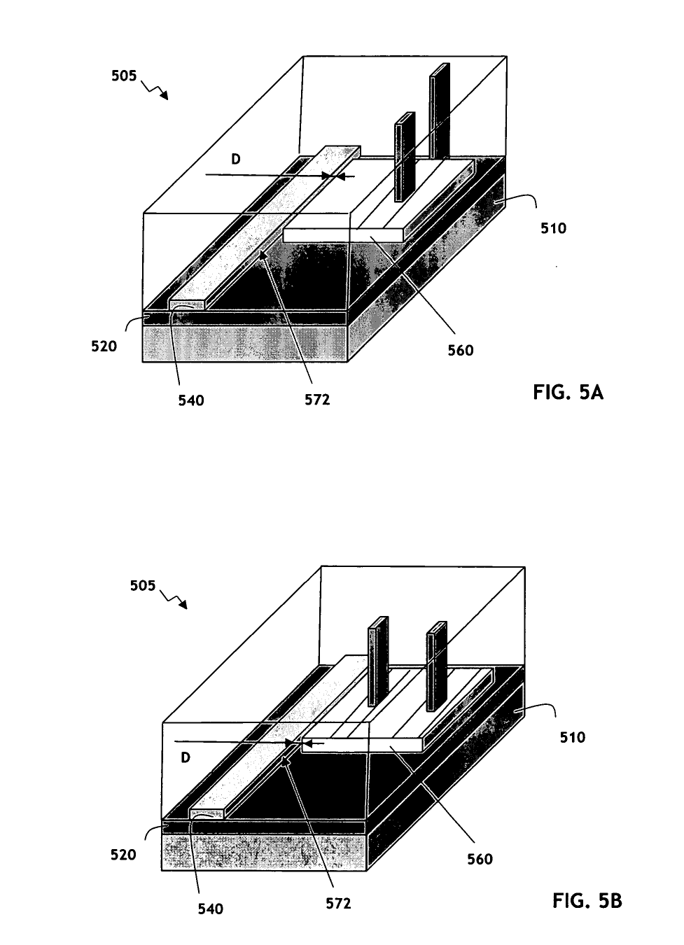

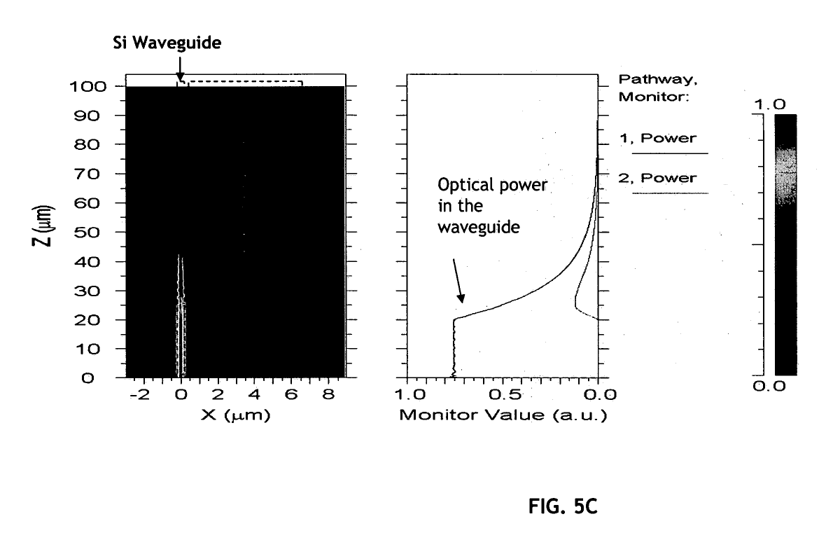

Referring to FIGS. 2B-2C, in many embodiments, the opening 150 is formed through the waveguide such that a butt end 156 of the waveguide 140 is part of the sidewall of the opening. In other embodiments, the opening is formed next to the waveguide such that its side surface, rather than the butt end, is part of the sidewalt of the opening, as depicted in FIG. 5A-5B and discussed in more detail below with reference to these Figures.

Referring now to FIG. 2B, an intermediate heterostructure 158 is formed by epitaxially depositing a photodetector layer 160 in the opening 150 at least partially over the first doped region 155. In various embodiments, the layer 160 contains, or consists essentially of, a lattice-mismatched semiconductor material. In some embodiments, as mentioned above, in order to reduce the effective thickness of the photodetector Layer thereby enhancing the detection speed, a thin layer of the same semiconductor material as the material of the base layer 110, for example, silicon, is deposited over the first doped region, followed by the deposition of the lattice-mismatched semiconductor material. The lattice-mismatched semiconductor material is selected depending, in part, on the desired optical absorption properties of the photodetector material for a given wavelength. In various embodiments, the lattice-mismatched semiconductor material is bulk germanium or a silicon-germanium alloy having a germanium concentration exceeding about 90%. As skilled artisans will readily recognize, for typical wavelengths used in optoelectronic applications, the optical absorption coefficient of bulk germanium disposed over silicon substrate is very high—e.g. about 9,000 cm⁻¹ for a wavelength of about 1.3 μm and between 2,000 and 4,000 cm⁻¹ for a wavelength of about 1.55 μm.

The lattice mismatch—i.e. the difference in crystalline lattice sizes between the base semiconductor layer 110 and the layer 160—creates stress during material deposition that generates dislocation defects in the resulting heterostructure. In order to improve the quality of the lattice-mismatched material of the layer 160, in various embodiments of the invention, multi-step epitaxial growth methods, such those described in, for example, U.S. Pat. Nos. 6,537,370 and 6,635,110, as well as in “Materials processing technology for the integration of effective Ge p-i-n photodetectors on Si for Si microphotonics,” Proceedings of SPIE,” vol. 4293, pgs. 118-122 (2001), all incorporated herein by reference, are employed. Specifically, in a particular embodiment, the epitaxial growth of the germanium layer 160 over the silicon layer 110 of the SOI wafer 100 (or over the intermediate silicon layer disposed over the layer 110 in the opening 150 underneath the layer 160, as described above) is carried out in two steps in an ultra-high vacuum chemical vapor deposition (UHVCVD) system. First, a thin (i.e. having a thickness ranging from about 30 nm to about 60 nm) substantially relaxed germanium buffer layer is epitaxiat grown at a temperature of about 350° C. in order to plastically relax the strain therein without formation of undesirable dislocation pile-ups. Then, the epitaxial growth continues at higher temperatures, e.g. about 600° C., until a desired final thickness of the layer 160 is obtained. In many embodiments, the final thickness of the layer 160 does not exceed about 1.5 μm, for example, is about 1 μm. As shown in FIGS. 2B-2C, in various embodiments, the final thickness of the photodetector 160 is selected such that it extends above the insulator layer 120 and is laterally aligned with the waveguide 140. In many embodiments, the epitaxial deposition of the photodetector material is controlled such that the side surface of the photodetector 160 extending above the insulator layer is smooth and gaplessly adjacent to the waveguide, such that the waveguide is in optical communication with and butt-coupled to the photodetector with minimal back-reflection of photocarriers at the interface between the waveguide and the photodetector.

In some embodiments, in order to further improve the quality of the layer 160 by facilitating removal of threading dislocations towards the edges of the heterostructure, the multi-step epitaxial growth may be supplemented by annealing the lattice-mismatched semiconductor material, for example, at a temperature of about 850° C.-900° C. for at least 15 minutes, or by rapid thermal annealing at a temperature greater than about 850° C. for about 3 minutes. Another suitable post-deposition method includes thermal cycling between 780° C. and 900° C. (e.g. 10 minutes at each temperature).

In addition, as skilled artisans will readily note, because the concentration of dislocation defects caused by the lattice mismatch between the photodetector material and the material of the base layer of the substrate generally decreases within the photodetector with the increasing distance from its interface with the base layer, the material quality in the top portion of the photodetector generally exceeds that of the rest of the photodetector. As shown in FIGS. 2B-2C, various embodiments of the invention take advantage of this quality gradient by implementing optical coupling of the waveguide 140 with the intrinsic region of the photodetector 160 in the top portion thereof.

In various embodiments of the invention, the waveguide is a single-mode structure, i.e. a structure in which only the lowest order bound mode can propagate at a given wavelength. Generally, the lowest order bound mode is ascertained for the given wavelength by solving Maxwell's equations for the boundary conditions imposed by the waveguide, e.g., core (spot) size and the refractive indices of the core and cladding. Thus, keeping in mind that the range of wavelengths typically used in optoelectronic applications is 1.3-1.55 μm, in some versions of these embodiments, the thickness of the optical waveguide is less than about 1 μm, for example, is about 0.2 μm. Also, in these or other versions, a width of the waveguide is less than about 1 μm, or, in a particular version, is about 0.5 μm.

The interface between the photodetector 160 formed, in some embodiments, of germanium or a silicon-germanium alloy with high germanium content and the top cladding layer formed of silicon dioxide or silicon oxynitride facilitates confinement of photocarriers within the intrinsic region of the photodetector device, such that substantially all unabsorbed light is back-reflected at the interface. As a result, unabsorbed photocarriers travel through the photodetector between the base silicon layer of the substrate and the top cladding layer, until fully absorbed. This phenomenon enables desirable detection capabilities of the photodetector while employing relatively thin layers of the absorbing material, thereby enhancing the detection speed. As mentioned above, in various embodiments, a thickness of the photodetector is less than about 1.5 μm, for example, is about 1 μm.

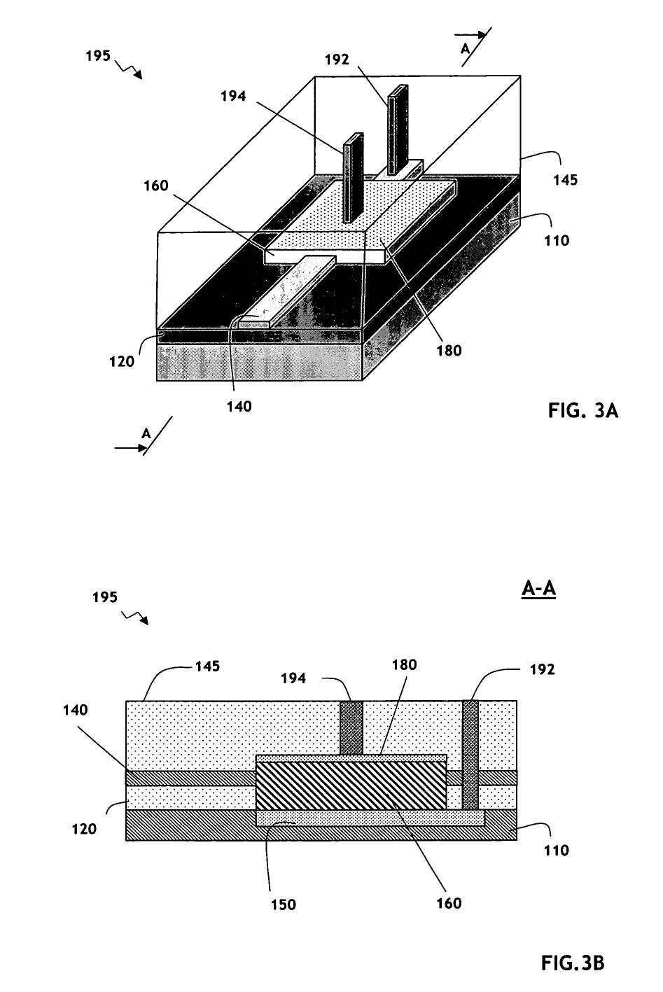

Referring now to FIGS. 3A-3B, in various embodiments, a second doped region 180 is formed in the exposed top surface of the photodetector by, for example, dopant implantation. In some embodiments, an semiconductor cap layer (not shown), formed of, for example, poly-silicon, is provided over a portion of the photodetector and the second doped region is formed in that cap layer. As mentioned above, examples of suitable dopants are n-type dopants such as phosphorus, arsenic, and antimony, or a p-type dopant, such as boron. Dopant ions are implanted using a dopant gas, such as phosphine, arsine, stibine, and diborane. The opening in the Layer 145 over the photodetector is then filled with the cladding material, such as, for example, silicon dioxide or silicon oxynitride. In various embodiments of the invention, one of the doped regions includes a source region and the other doped region includes a drain region of the photodetector apparatus having PIN configuration. Further, in order to provide electrical communication with the source and drain regions, contact regions 192, 194 are formed employing any of the methods known in the art. For example, in some embodiments, contact holes are defined over the regions 155, 180. The contact holes are then filled with a contact material. In a particular embodiment, the contact material is a metal compound that is thermally stable and has low electrical resistivity at the semiconductor/refractory metal interface, such as a metal germanicide and/or metal siticide including, for example, cobalt, titanium, tungsten, molybdenum, platinum, nickel, or tantalum. Preferably, the contact regions are formed by a self-aligned process, in which the contacts are formed only in the areas where the deposited metal is in direct contact with the source/drain regions. As a result, a butt-coupled integrated waveguide-based photodetector apparatus 195 employing a vertical PIN configuration is fabricated. Because of the compact coupling of the components, integration density and detection speed and sensitivity are generally enhanced.

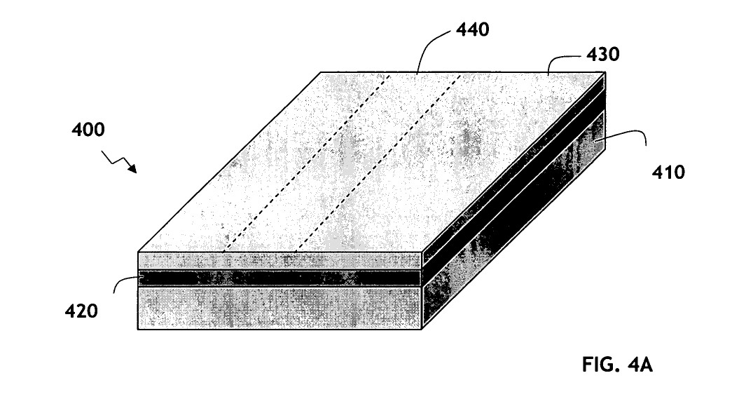

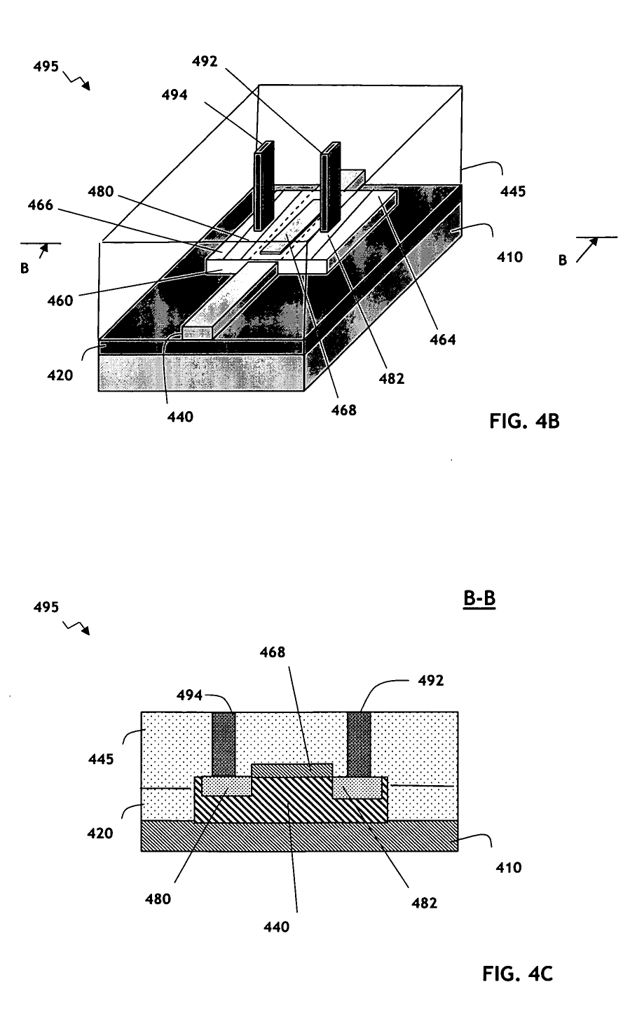

Referring to FIGS. 4A-4C, in some embodiments (and similarly to the embodiments described above in connection with preceding figures), fabrication of the waveguide-based photodetector apparatus having a lateral PIN configuration starts with a substrate 400 including a base semiconductor layer 410 and an insulator layer 420 disposed thereon. The insulator layer will ultimately serve as a bottom cladding layer of the waveguide. A top semiconductor layer 430 is disposed over the insulator layer. In a particular embodiment, the substrate 400 is a SOI wafer such that the top and the base semiconductor layers consist essentially of single-crystal silicon and the insulator layer consists essentially of silicon dioxide. A waveguide 440 is defined in the layer 430, for example, by masking the desired configuration of the waveguide using a patterned photoresist layer and then etching the exposed portions of the layer 430. A top cladding layer 445 (depicted in FIG. 4B-4C as having transparent sides and visible edges for illustration purposes) is deposited over the waveguide 440 and the insulator layer 420 by, for example, any of conventional chemical vapor deposition techniques. In many embodiments, the top cladding layer contains, or consists essentially of, silicon dioxide or silicon oxynitride.

Referring to FIGS. 4B-4C, in many embodiments, an opening (not shown) is then defined in the substrate 400 through the top cladding layer and the insulator layer, and, optionally, through the top semiconductor later, extending to the top surface of the base layer. The opening can be formed by any method known in the art, for example, by applying a patterned photoresist layer over the top semiconductor layer followed by etching of portions of the layers exposed by the photoresist. In many embodiments, the opening is formed through the waveguide such that a butt end of the waveguide is part of the sidewall of the opening. In other embodiments, the opening is formed next to the waveguide such that its side surface, rather than the butt end, is part of the sidewall of the opening, as depicted in FIG. 5A-5B and discussed in more detail below with reference to these Figures.

Still referring to FIG. 4B-4C, a photodetector layer 460 is epitaxially deposited over the exposed portion of the base layer 410 in the opening. In various embodiments, the layer 460 contains, or consists essentially of, a lattice-mismatched semiconductor material, for example, bulk germanium or a silicon-germanium alloy having a germanium concentration exceeding about 90%. In some embodiments, similarly to the embodiments described above with reference to FIGS. 2A-2C, a thin layer of the same semiconductor material as the material of the base layer 410, for example, silicon, is deposited in the opening over the exposed portion of the base layer 110, followed by the deposition of the lattice-mismatched semiconductor material. Also, similarly to the embodiments described above with reference to FIGS. 3A-3B, in order to improve the quality of the lattice-mismatched material of the layer 460, in various embodiments of the invention, multi-step epitaxial growth methods are employed in conjunction with post-deposition annealing.

Further, in some embodiments, an auxiliary semiconductor layer, for example, containing, or consisting essentially of, poly-silicon, germanium, or a silicon-germanium alloy with relatively low germanium content, is epitaxially deposited over the photodetector 490. Portions of the auxiliary layer are optionally removed, as shown in FIGS. 4B-4C, such that portions 464, 466 of the top surface of the photodetector are exposed and a semiconductor region 468 remains over a central portion of the photodetector between the portions 464, 466. In various embodiments of the invention, the removal is accomplished by photoresist and then dry and/or wet etching.

Further, in various embodiments, a source region 480 and a drain region 482 are formed in the portions 464, 466, respectively, by, for example, dopant implantation. As mentioned above, examples of suitable dopants are n-type dopants such as phosphorus, arsenic, and antimony, or a p-type dopant, such as boron. The dopant ions may be implanted using a dopant gas, such as phosphine, arsine, stibine, and/or diborane. Then, the opening in the layer 445 over the photodetector is filled with the cladding material, such as, for example, silicon dioxide or silicon oxynitride.

As mentioned above, in some embodiments, the auxiliary semiconductor region 468 is disposed over the intrinsic region of the photodetector between the source and drain regions. In these embodiments, a refractive index of the region 468 formed of, for example, silicon, germanium or a silicon-germanium alloy, exceeds that of the cladding material. Accordingly, the existence of additional high-refractive-index material region 468 over the photodetector causes increased concentration of photocarriers underneath the region 468, for example, in the central portion of the intrinsic region where the electric field is stronger, thereby enhancing the detection speed.

Further, contact regions 492, 494 are formed to provide electrical communication with the source and drain regions employing methods known in the art, as described above with reference to FIGS. 3A-3B. As a result, an integrated waveguide-based photodetector apparatus 495 employing a lateral PIN configuration is fabricated. Because of the compact coupling and design configuration of the components, integration density and detection speed and sensitivity are generally enhanced.

Referring to FIGS. 5A-5B, in certain alternative embodiments of the claimed invention, an integrated waveguide-based photodetector apparatus 500 employing either vertical (FIG. 5A) or lateral (FIG. 5B) PIN configuration includes a waveguide 540 evanescently coupled to the photodetector 560. Fabrication of the apparatus 500 is generally carried out as described above with reference to the preceding Figures, except for the placement of the waveguide. In contrast to the configuration where the butt end of the waveguide is part of the sidewall of the opening in the layers 120, 220, 145, and 445 (FIGS. 2A, 3A, and 4B), the opening is formed in relation to the waveguide such that a side surface 572 of the waveguide is disposed proximate or directly adjacent to the photodetector 560 formed in the opening. In some versions of these embodiment, the epitaxial deposition of the photodetector material is controlled such that the side surface of the photodetector 560 extending above the insulator layer 520 is smooth and gaplessly adjacent to the side surface 572 of the waveguide, such that the waveguide is evanescently coupled to the photodetector with minimal back-reflection of photocarriers at the interface between the waveguide and the photodetector. In other versions of the embodiments described with reference to FIGS. 5A-5B, there is a gap D between the side surface 572 of the waveguide and the photodetector. In these versions, in order to maintain the coupling between the waveguide and the photodetector, the gap D may not exceed the distance beyond which the evanescent tail of the wavelength does not reach the photodetector, and, therefore, the upper limit of the gap generally depends on the wavelengths used in the specific optoetectronic applications. In some embodiments, the gap D does not exceed about 0.25 μm, for example, is about 0.1 μm. FIG. 5C depicts an optical simulation of a transverse field profile for the embodiment of the evanescently-coupled integrated device shown in FIG. 5B with a 0.1-μm gap between the waveguide and the photodetector.

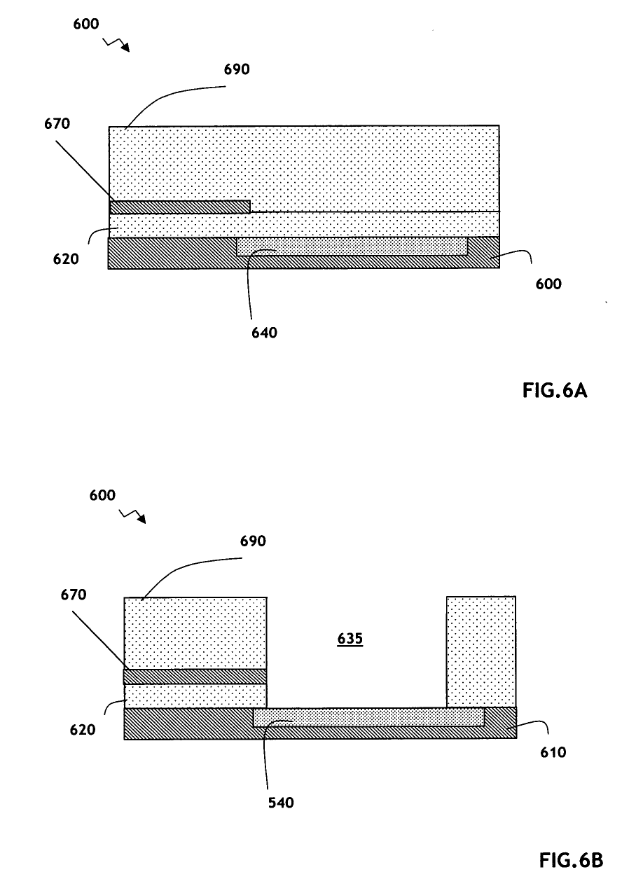

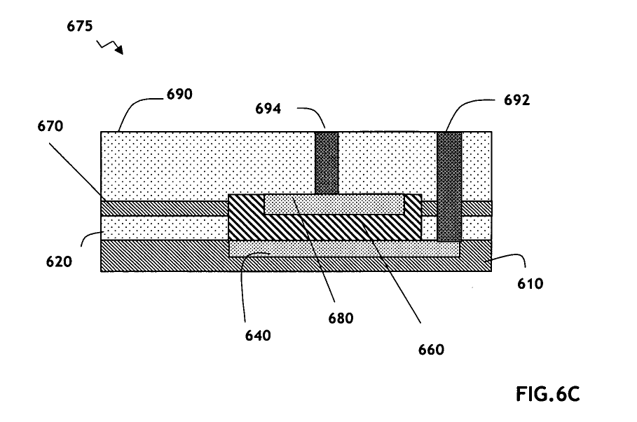

Referring now to FIGS. 6A-6C, in yet other embodiments of the invention (and in contrast with the embodiments described above in connection with preceding Figures), fabrication of the waveguide-based photodetector apparatus starts with a single-layer substrate 610, rather than a multi-layer substrate having an insulator layer disposed between two semiconductor layers, e.g. a SOI wafer. In these alternative embodiments, the substrate 610 contains, or consists essentially of, a semiconductor material, such as, for example, single-crystal silicon. This alternative approach affords flexibility in choosing suitable materials for the waveguide, rather than being limited to the material of the top semiconductor layer of the multi-layer substrate. While discussed in more detail below in connection with fabrication of a butt-coupled photodetector apparatus having vertical PIN configuration, this approach can be employed in conjunction with other embodiments described above in connection with preceding Figures, including the apparatus having lateral PIN configuration.

Referring to FIG. 6A, the starting substrate 610 is doped. In other versions, a first doped region 640 is formed in the substrate by, for example, ion implantation, as described above. In yet other versions, a first doped region along with a drain region can be formed by ion implantation in the top surface of the photodetector.

Still referring to FIG. 6A, a bottom cladding layer 620 is deposited over the substrate 610. The bottom cladding layer may contain, or consist essentially of silicon dioxide. A waveguide 670 is then deposited over the bottom cladding layer in a desired configuration using a patterned photoresist. The waveguide may contain, or consist essentially of, amorphous or polycrystalline silicon, silicon nitride, or silicon oxynitride. Further, a top cladding layer 690 that may contain, or consist essentially of, silicon dioxide is deposited over the waveguide and the insulator layer.

Referring now to FIG. 6B, a photoresist mask is applied to the top cladding layer 690 defining placement of the photodetector, and then an opening 635 extending to the surface of the substrate 610, for example, at least partially over the first doped region 640, is formed by etching or other methods known in the art. Similarly to the embodiments described above, the waveguide 670 and the opening 635 may be configured such that, in some embodiments, the butt end of the waveguide is disposed adjacent to the edge of the opening in the bottom cladding layer, or, in other embodiments, disposed such that a side surface of the waveguide is disposed proximate or adjacent to the the edge of the opening.

Referring to FIG. 6C, a photodetector layer 660 is epitaxially deposited over the substrate 610 in the opening 635. In various embodiments, the layer 660 contains, or consists essentially of, a lattice-mismatched semiconductor material, for example, bulk germanium or compositionally-uniform silicon-germanium alloy having a germanium concentration exceeding about 90%. In some embodiments, a thin layer of the same semiconductor material as the material of the substrate 610, for example, silicon, is deposited in the opening 635 over the exposed surface of the substrate (and, in some embodiments, over the first doped region 640), followed by the deposition of the compositionally-uniform lattice-mismatched semiconductor material. As described above, in order to improve the quality of the lattice-mismatched material of the Layer 660, in various embodiments of the invention, multi-step epitaxial growth methods are employed in conjunction with post-deposition annealing.

With continued reference to FIG. 6C, in some embodiments, a second doped region 680 is formed over the exposed surface of the photodetector 660 by, for example, ion implantation, as described above, thereby forming a vertical PIN structure, in which one of the doped regions includes a source region and the other doped region includes a drain region of the photodetector apparatus having PIN configuration. In other embodiments, both source and drain regions (not shown) can be formed in the photodetector, resulting in a Lateral PIN structure. After the drain region (or both source and drain regions) are formed, the remainder of the opening 635 over the photodetector 660 is filled with the cladding material, such as, for example, silicon dioxide or silicon oxynitride. Further, in order to provide electrical communication with the source and drain regions, contact regions 692, 694 are formed employing any of the methods known in the art.

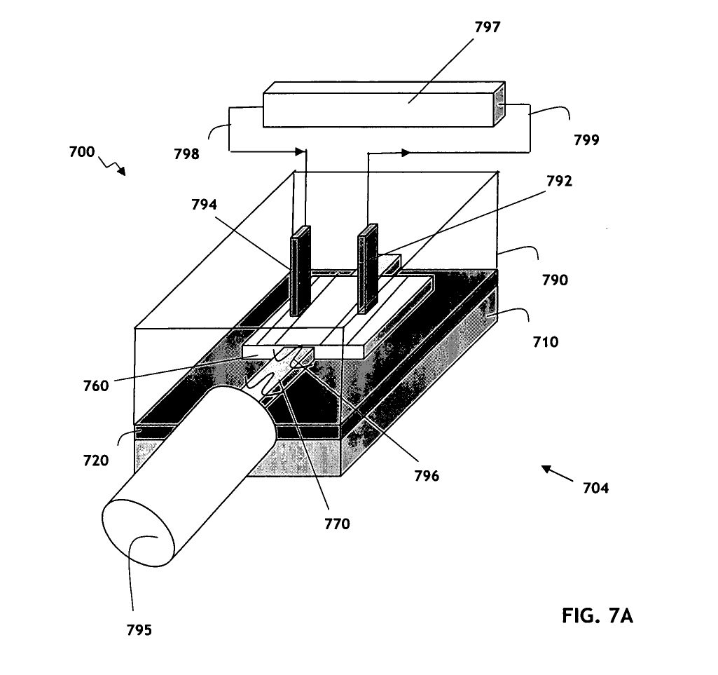

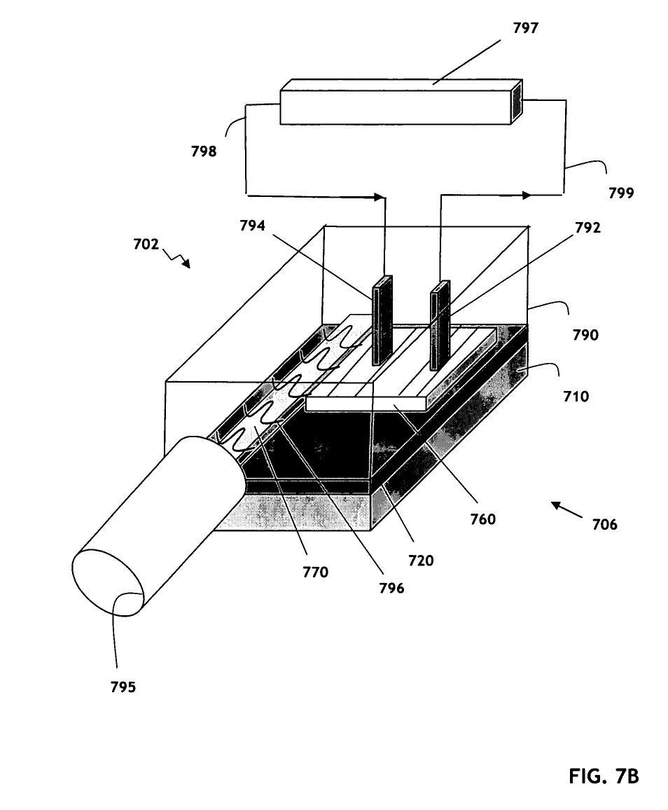

As mentioned above, various optoelectronic circuits can be fabricated employing integrated photodetector apparatus implemented according to any of the embodiments described above. Referring to FIGS. 7A-7B, in some embodiments, optoelectronic circuits 700, 702 include the integrated photodetector apparatus 704, 706, employing a Lateral PIN configuration and fabricated as described in connection with FIGS. 4B-4C and 5A-5B, respectively. In particular, both apparatus 704, 706 are formed over a substrate having a base layer 710 and an insulator layer 720 disposed thereover, and include an optical waveguide 770 defined over the insulator layer and a photodetector 760 coupled thereto. The photodetector 760 is epitaxially deposited in the opening in the insulator layer over the base layer and is laterally aligned with the waveguide. In the apparatus 704, the waveguide is butt-coupled to the photodetector, as shown in FIG. 7A. In the apparatus 706, the waveguide is evanescently coupled to the photodetector, as shown in FIG. 7A. The source and drain regions are formed in the photodetector and contact regions 792, 794 are fabricated to provide electrical communication therewith.

The circuits 700, 702 further include an optical or optoelectronic device 795 optically coupled to the optical waveguide at its input end. The device 795 is capable of generating an optical signal carried by or otherwise represented by lightwave 796. In a particular embodiment, the device 795 includes a microprocessor (not shown) and a light-emitting device (not shown) such as a diode laser or a light-emitting diode. The circuits 700, 702 further include an electronic or optoelectronic device 797 electrically coupled to the contact regions of the photodetector via wires 798, 799. The device 797 is any device capable of receiving and processing an electrical signal generated in the photodetector, including, but not limited to, a microprocessor, a filter, an amplifier, or any combination thereof. The device 797 could include or be further connected to any other type of signal-processing element or circuit.

In operation, the device 795 emits an optical signal represented by or carried by the lightwave 796, which is coupled into optical waveguide 720. The lightwave propagates in through waveguide until it is directly (FIG. 7A) or evanescently (FIG. 7B) coupled into the intrinsic region of the photodetector 790. The light in intrinsic region is converted to photon-generated carriers, which diffuse to contact regions resulting in the electrical signal. The electrical signal is then carried to and processed by the device 797.

Other embodiments incorporating the concepts disclosed herein, as well as many modifications, variations, and changes to the embodiments described above, are possible without departing from the spirit of the essential characteristics of the invention or the scope thereof. The foregoing embodiments are therefore to be considered in all respects as only illustrative rather than restrictive of the invention described herein. Therefore, it is intended that the scope of the invention be only limited by the following claims.

1. An integrated photodetector apparatus comprising
(a) a substrate comprising a first cladding layer disposed over a base layer, the base layer comprising a first semiconductor material, the first cladding layer defining an opening extending to the base layer;
(b) an optical waveguide comprising the first semiconductor material and disposed over the substrate; and
(c) a photodetector comprising a second semiconductor material epitaxially grown over the base layer at least in the opening, the photodetector comprising an intrinsic region optically coupled to the waveguide, at least a portion of the intrinsic region extending above the first cladding layer and laterally aligned with the waveguide.

2. The photodetector apparatus of claim 1 wherein the intrinsic region of the photodetector is butt-coupled to the optical waveguide.

3. The photodetector apparatus of claim 1 wherein the intrinsic region of the photodetector is evanescently coupled to the optical waveguide.

4. The photodetector apparatus of claim 3 wherein a gap between the photodetector and the optical waveguide is less than about 1 μm.

5. The photodetector apparatus of claim 1 wherein the portion of the intrinsic region of the photodetector is adjacent to the optical waveguide, forming substantially gapless interface therebetween.

6. The photodetector apparatus of claim 1 wherein the first semiconductor material comprises single-crystal silicon and the first cladding layer comprises silicon dioxide.

7. The photodetector apparatus of claim 1 wherein the photodetector consists essentially of germanium.

8. The photodetector apparatus of claim 1 wherein the photodetector comprises germanium or a silicon-germanium alloy having a germanium concentration exceeding about 90%.

9. The photodetector apparatus of claim 1 wherein the waveguide is a single-mode structure.

10. The photodetector apparatus of claim 9 wherein the width of the optical waveguide is about 0.5 μm.

11. The photodetector apparatus of claim 9 wherein the thickness of the optical waveguide is about 0.2 μm.

12. The photodetector apparatus of claim 1 wherein the thickness of the photodetector does not exceed about 1.5 μm.

13. The photodetector apparatus of claim 1, further comprising a second cladding Layer disposed over the optical waveguide and the photodetector.

14. The photodetector apparatus of claim 13 wherein the second cladding layer comprises silicon dioxide.

15. The photodetector apparatus of claim 1, further comprising an intermediate semiconductor layer disposed over the base layer in the opening underneath the photodetector.

16. The photodetector apparatus of claim 15 wherein the intermediate semiconductor layer comprises silicon.

17. The photodetector apparatus of claim 1 wherein the photodetector further comprises a source region and a drain region separated by the intrinsic region.

18. The photodetector apparatus of claim 17, further comprising contact regions in electrical communication with the source and the drain regions.

19. An integrated photodetector apparatus comprising
(a) a substrate comprising a first cladding layer disposed over a base layer, the first cladding layer defining an opening extending to a first portion of the base layer, the base layer comprising a first semiconductor material and a first doped region formed at least in the first portion of the base layer;
(b) an optical waveguide comprising the first semiconductor material and disposed over the substrate; and
(c) a photodetector comprising a second semiconductor material epitaxially grown over the base layer at least in the opening over the source region, the photodetector comprising a second doped region and an intrinsic region thereunder optically coupled to the waveguide, at least a portion of the intrinsic region extending above the first cladding layer and laterally aligned with the waveguide, one of the doped regions comprising a source region and the other doped region comprising a drain region.

20. An integrated photodetector apparatus comprising
(a) an optical waveguide disposed over a substrate including a first cladding layer disposed over a base layer, the first cladding layer comprising silicon dioxide and defining an opening extending to the base layer, the optical waveguide and the base layer comprising single-crystal silicon;
(b) an intermediate silicon layer disposed in the opening over the base layer and comprising a first doped region formed therein; and
(c) a photodetector comprising a semiconductor material epitaxially grown at least in the opening over the intermediate layer, the photodetector comprising a second doped region and an intrinsic region thereunder optically coupled to the waveguide, at least a portion of the intrinsic region extending above the first cladding layer and in lateral alignment with the waveguide, one of the doped regions comprising a source region and the other doped region comprising a drain region.

21. An optoelectronic circuit comprising
(a) an integrated photodetector apparatus, comprising
an optical waveguide disposed over a substrate including a first cladding layer disposed over a base layer, the first cladding layer comprising silicon dioxide and defining an opening extending to the base layer, the optical waveguide and the base layer comprising single-crystal silicon; and
a photodetector comprising a semiconductor material epitaxially grown over the base layer at least in the opening, the photodetector comprising a source and a drain regions separated by an intrinsic region optically coupled to the waveguide, at least a portion of the intrinsic region extending above the first cladding layer in lateral alignment with the waveguide;
(b) a light source in optical communication with an input end of the optical waveguide for directing a lightwave thereto; and
(c) an electronic device electrically coupled to the source and drain regions for receiving and processing an electrical signal generated in the photodetector.

22. An optoelectronic circuit comprising
(a) an integrated photodetector apparatus, comprising
an optical waveguide disposed over the substrate including a first cladding layer disposed over a base layer, the first cladding layer comprising silicon dioxide and defining an opening extending to a first portion of the base layer, the base layer comprising a first doped region formed at least in the first portion of the base layer, the optical waveguide and the base layer comprising single-crystal silicon; and
a photodetector comprising a semiconductor material epitaxially grown over the base layer at least in the opening over the source region, the photodetector comprising a second doped region and an intrinsic region thereunder optically coupled to the waveguide, at least a portion of the intrinsic region extending above the first cladding layer and in lateral alignment with the waveguide, one of the doped regions comprising a source region and the other doped region comprising a drain region;
(b) a light source in optical communication with an input end of the optical waveguide for directing a lightwave thereto; and
(c) an electronic device electrically coupled to the source and drain regions for receiving and processing an electrical signal generated in the photodetector.

23. A method for manufacturing an integrated photodetector apparatus, the method comprising:
(a) providing a silicon-on-insulator substrate including a top layer, an insulator layer, and a base layer;
(b) partially removing the top layer to form an optical waveguide over the insulator layer;
(c) depositing a cladding layer comprising silicon dioxide over the optical waveguide and the insulator layer;
(d) forming an opening at least through the cladding layer and the insulator layer extending to a first portion of the base layer; and
(e) epitaxially growing a lattice-mismatched semiconductor layer over the first portion of the base layer at least in the opening, at least a portion of the semiconductor layer extending above the insulator layer to form a photodetector including an intrinsic region optically coupled to the waveguide.

24. The method of claim 23, further comprising, prior to epitaxially growing a lattice-mismatched semiconductor layer, forming a first doped region in the first portion of the base layer.

25. The method of claim 24, further comprising forming a second doped region in the photodetector, one of the doped regions comprising a source region and the other doped region comprising a drain region.

26. The method of claim 25, further comprising forming contact regions electrically coupled to the source and drain regions.

27. The method of claim 23, further comprising forming a source region and a drain region in the photodetector.

28. The method of claim 27, further comprising forming contact regions electrically coupled to the source and drain regions.

29. The method of claim 23, further comprising, prior to epitaxially growing a lattice-mismatched semiconductor layer, depositing an intermediate silicon layer in the opening over the base layer.

30. The method of claim 23 wherein the lattice-mismatched semiconductor layer comprises germanium or a silicon-germanium alloy having a germanium concentration exceeding about 90%.

31. The method of claim 23 wherein the intrinsic region of the photodetector is butt-coupled to the optical waveguide.

32. The method of claim 23 wherein the intrinsic region of the photodetector is evanescently coupled to the optical waveguide.

33. The method of claim 23 wherein the portion of the semiconductor layer is adjacent to the optical waveguide forming substantially gapless interface therebetween.

34. The method of claim 23 wherein the step of epitaxially growing the lattice-mismatched semiconductor layer comprises:
(a) depositing a semiconductor material over the interface layer at a first temperature to form a buffer layer; and
(b) depositing the semiconductor material over the buffer layer at a second temperature until a final thickness is obtained.

35. The method of claim 34 wherein a thickness of the buffer layer ranges from about 30 nm to about 60 nm.

36. The method of claim 34 wherein the final thickness does not exceed about 1.5 μm.

37. The method of claim 34 wherein the second temperature is greater than the first temperature.

38. The method of claim 34 wherein the step of epitaxially growing the lattice-mismatched semiconductor layer further comprises annealing the semiconductor material.

39. A method for manufacturing an integrated photodetector apparatus, the method comprising:
(a) providing a silicon substrate;
(b) forming a first insulator layer over the substrate;
(c) forming an optical waveguide over the insulator layer, the optical waveguide comprising silicon, silicon nitride, or silicon oxynitride;
(d) depositing a second insulator layer over the optical waveguide and the first insulator layer;
(e) forming an opening at least through the first and second insulator layers extending to a first portion of the substrate; and
(f) epitaxially growing a compositionally-uniform lattice-mismatched semiconductor layer directly over the first portion of the substrate at least in the opening, at least a portion of the semiconductor layer extending above the insulator layer to form a photodetector including an intrinsic region optically coupled to the waveguide.
